(19) United States
(12) Patent Application Publication
(10) Pub. No.: US 2024/0380200 A1
(43) Pub. Date: Nov. 14, 2024

(54) AIRCRAFT DC POWER BUS REGULATION AND WING DE-ICER

(71) Applicant: Rolls-Royce North American Technologies Inc., Indianapolis, IN (US)

(72) Inventor: Brian Huber, Indianapolis, IN (US)

(21) Appl. No.: 18/144,425

(22) Filed: May 8, 2023

(51) Int. Cl. H02J 1/08; H02J 1/14

(52) U.S. Cl. CPC H02J 1/082; H02J 1/14; B64D 15/12; B64D 2221/00; H02J 2310/44

(57) ABSTRACT

A power distribution system for an aircraft includes a wing, a power supply circuit, and a controller. The supply circuit includes a DC power bus having a voltage, a resistive heating element electrically connected with the DC power bus and coupled with the wing, and a voltage manipulation element configured to selectively adjust an amount of voltage that is directed to the heating element. The controller is connected to the manipulation element and is configured to regulate the voltage of the DC power bus. The controller is programmed to control the manipulation element when the voltage of the DC power bus is greater than a threshold voltage to vary an amount of voltage that is directed to the heating element to cause the heating element to convert the amount of the voltage into heat and thereby regulate overvoltage of the voltage of the DC power bus.

### FIELD OF THE DISCLOSURE

The present disclosure relates generally to propulsion systems, and more specifically to propulsion systems including electric propulsion components.

### BACKGROUND

Electrical systems of aircraft include a wide variety of electrical components and circuitry configured to operate the numerous mechanical, electrical, and computational components of the aircraft. Such componentry may include avionics, lighting, flight control surfaces, and the like. Power supplied to these components must be regulated to efficiently deliver voltage and power while preventing undesirable fluctuations, fault scenarios, and similar situations from occurring. A component included in such regulation is a DC power bus that is configured to distribute voltage to various electrical components of the aircraft's electrical system. It is desirable in such electrical systems to regulate any fault scenarios or overvoltage of the DC power bus.

### SUMMARY

The present disclosure may comprise one or more of the following features and combinations thereof.

According to a first aspect of the present disclosure, a power distribution system for an aircraft includes at least one wing of the aircraft, a power supply circuit, and a controller. The power supply circuit includes at least one DC power bus having a first voltage, at least one resistive heating element electrically connected with the at least one DC power bus and coupled with the at least one wing of the aircraft, and at least one voltage manipulation element configured to selectively adjust an amount of the first voltage that is directed to the at least one resistive heating element.

In some embodiments, the controller is electrically connected to the at least one voltage manipulation element of the power supply circuit and configured to regulate the first voltage of the DC power bus. The controller is programmed to selectively control the at least one voltage manipulation element in response to the first voltage of the DC power bus being greater than a first threshold voltage to vary an amount of the first voltage that is directed to the at least one resistive heating element to cause the at least one resistive heating element to convert the amount of the first voltage into heat and thereby regulate overvoltage of the first voltage of the DC power bus.

In some embodiments, the at least one voltage manipulation element is connected across the DC power bus and is a gate switch configured to be arranged in an on position and an off position, and the controller is configured to selectively control the gate switch to the on and off positions.

In some embodiments, the gate switch is arranged along an electrical line extending between and electrically connecting a negative side of the DC power bus and the at least one resistive heating element.

In some embodiments, the controller is configured to send a duty cycle signal to the gate switch indicative of a duty cycle to be applied to the gate switch, wherein the duty cycle to be applied to the gate switch is equal to a first duration in which the gate switch remains in the on position divided by a total cycle duration of the duty cycle signal, the total cycle duration being the first duration plus a second duration in which the gate switch in is the off position, and the duty cycle signal causes the gate switch to move between the on position and the off position such that the gate switch remains in the on position for the first duration such that the desired amount of the first voltage is directed to the at least one resistive heating element during the first duration.

In some embodiments, the controller is configured to repeatedly send the duty cycle signal to the gate switch so as to repeatedly move the gate switch between the on and off positions at a first frequency.

In some embodiments, the duty cycle to be applied to the gate switch is based on a difference between the first voltage and the first threshold voltage.

In some embodiments, the first duration in which the gate switch remains in the on position of the duty cycle to be applied to the gate switch is directly proportional to the difference between the first voltage and the first threshold voltage.

In some embodiments, the at least one resistive heating element includes a plurality of resistive heating elements arranged within the at least one wing, and each resistive heating element of the plurality of resistive heating elements includes a corresponding gate switch electrically connected thereto and configured to adjust an amount of the first voltage that flows to the corresponding resistive heating element.

In some embodiments, the plurality of resistive heating elements include at least one group of at least two resistors arranged in parallel.

In some embodiments, the power distribution system further includes at least one sensor connected to the DC power bus and configured to measure the first voltage of the DC power bus.

In some embodiments, the plurality of resistive heating elements include at least one additional resistive heating element electrically connected across the at least one DC power bus and arranged within a further component of the aircraft separate from the at least one wing.

According to a further aspect of the present disclosure, power distribution system for an aircraft includes a power supply circuit including at least one DC power bus having a first voltage and at least one electrical resistive element electrically connected with the at least one DC power bus, and a controller electrically connected to the power supply circuit and configured to regulate the first voltage of the DC power bus. The controller is configured to selectively control an amount of the first voltage that is directed to the at least one electrical resistive element in response to the first voltage being greater than a first threshold voltage to vary an amount of the first voltage that is directed to the at least one electrical resistive element to cause the at least one electrical resistive element to regulate overvoltage of the first voltage of the DC power bus.

In some embodiments, wherein the power distribution system further includes at least one component of the aircraft. The at least one electrical resistive element is coupled with the at least one component of the aircraft.

In some embodiments, the power supply circuit further includes at least one voltage manipulation element configured to selectively adjust an amount of the first voltage that is directed to the at least one resistive heating element, and the controller is programmed to selectively control the at least one voltage manipulation element in response to the first voltage of the DC power bus being greater than the first threshold voltage.

In some embodiments, the at least one voltage manipulation element is connected across the DC power bus and is a gate switch configured to be arranged in an on position and an off position, and the controller is configured to selectively control the gate switch to the on and off positions.

In some embodiments, the controller is configured to send a duty cycle signal to the gate switch indicative of a duty cycle to be applied to the gate switch, wherein the duty cycle to be applied to the gate switch is equal to a first duration in which the gate switch remains in the on position divided by a total cycle duration of the duty cycle signal, the total cycle duration being the first duration plus a second duration in which the gate switch in is the off position, and the duty cycle signal causes the gate switch to move between the on position and the off position such that the gate switch remains in the on position for the first duration such that the desired amount of the first voltage is directed to the at least one resistive heating element during the first duration.

In some embodiments, the duty cycle to be applied to the gate switch is based on a difference between the first voltage and the first threshold voltage.

In some embodiments, the first duration in which the gate switch remains in the on position of the duty cycle to be applied to the gate switch is directly proportional to the difference between the first voltage and the first threshold voltage.

In some embodiments, the at least one resistive heating element includes a plurality of resistive heating elements arranged within the at least one component, and each resistive heating element of the plurality of resistive heating elements includes a corresponding gate switch electrically connected thereto and configured to adjust an amount of the first voltage that flows to the corresponding resistive heating element.

According to a further aspect of the present disclosure, a method includes providing at least one wing of an aircraft and providing a power supply circuit. The providing of the power supply includes providing at least one DC power bus having a first voltage, electrically connecting at least one resistive heating element with the at least one DC power bus, coupling the at least one resistive heating element with the at least one wing of the aircraft, and arranging at least one voltage manipulation element in the power supply circuit that is configured to selectively adjust an amount of the first voltage that is directed to the at least one resistive heating element. In some embodiments, the method can further include electrically connecting a controller to the at least one voltage manipulation element of the power supply circuit, the controller being configured to regulate the first voltage of the DC power bus, the controller being programmed to selectively control the at least one voltage manipulation element in response to the first voltage of the DC power bus being greater than a first threshold voltage to vary an amount of the first voltage that is directed to the at least one resistive heating element to cause the at least one resistive heating element to convert the amount of the first voltage into heat and thereby regulate overvoltage of the first voltage of the DC power bus.

These and other features of the present disclosure will become more apparent from the following description of the illustrative embodiments.

### BRIEF DESCRIPTION OF THE DRAWINGS

FIG. 1 is a perspective view of an aircraft according to the present disclosure, the aircraft including a fuselage, two wings, two propulsion systems each coupled to the wings, and a power distribution system configured to regulate a voltage of a power supply circuit and direct an amount of the regulated voltage to resistive elements coupled to an aircraft component such as the wings in order to provide heat in that region;

FIG. 2 is a schematic view of the power distribution system of FIG. 1, showing that the system includes a power supply circuit including a DC power bus, four resistive heating elements electrically connected with the DC power bus and coupled with the wings, a gate switch connected to each resistive heating element, and a controller connected to each gate switch and configured to selectively adjust an amount of voltage that is directed to the resistive heating elements from the DC power bus via the gate switches;

FIG. 3 is a schematic view of a gate switch of the power distribution system of FIG. 2;

FIG. 4 is graphical view of exemplary duty cycles to be utilized with the power distribution system of FIG. 2; and

FIG. 5 is a schematic view of the power distribution system according to a further aspect of the present disclosure, showing that resistive heating elements may be arranged in other components of the aircraft in addition to or alternatively to the wings, such as the horizontal stabilizer.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

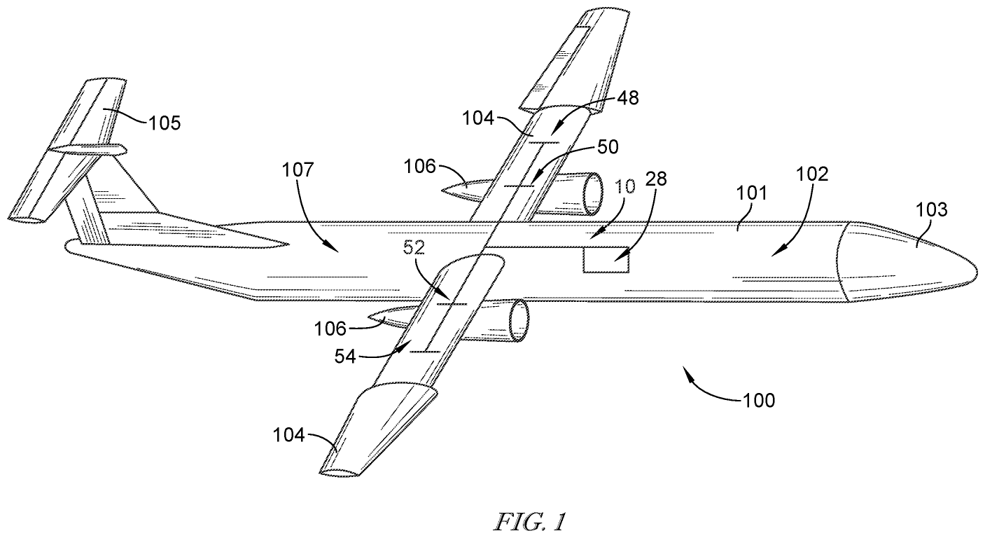

An aircraft 100 including at least one power distribution system 10 according to the present disclosure is shown in FIG. 1. In the illustrative embodiment, the aircraft 100 may include a fuselage 101 and a pair of wings 104 extending away from the fuselage 101 and configured to generate lift for the aircraft 100. The fuselage 101 may include a forward portion 102 forward of the wings 104 and an aft portion 107 aft of the wings 104. The aircraft 100 may further include a horizontal stabilizer 105 arranged at an aft end of the aft portion 107 of the fuselage 101.

The aircraft 100 may further include a pair of propulsion systems 106, such as, for example, a propeller, an electrically driven engine, or a gas turbine engine. In other embodiments, there may be greater than or fewer than two propulsion systems 106 coupled to the aircraft 100, such as, for example, two propulsion systems 106 arranged on each wing 104 or a single propulsion system 106 arranged at the nose 103 of the fuselage 101.

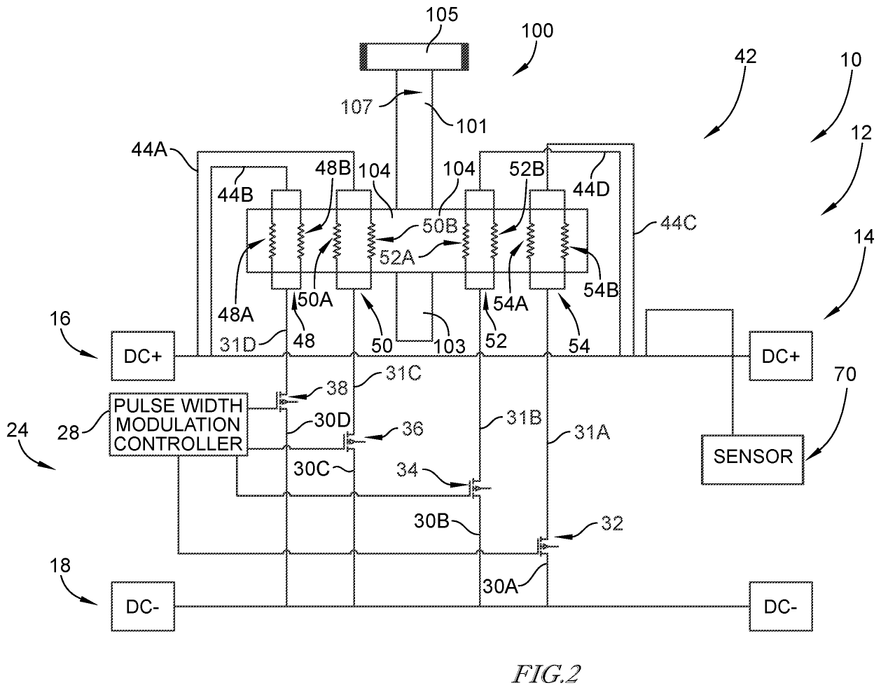

As can be seen in FIGS. 1 and 2, the aircraft 100 may further include a power distribution system 10 having a controller 28 and a plurality of resistive heating elements 48, 50, 52, 54 embedded in the wings 104 of the aircraft 100. As will be described in detail below, the controller 28 may regulate voltage a DC power bus 14 of the power distribution system 10 so as to direct a portion of the voltage of the DC power bus 14 to the resistive heating elements 48, 50, 52, 54 such that the resistive elements 48, 50, 52, 54 convert the voltage flowing therethrough to heat so as to de-ice the wings 104 of the aircraft 100.

DC power buses are utilized to regulate, stabilize, and distribute voltage and power to various components in electrical systems. DC power buses can be particularly effective at managing fluctuations in voltage supplies and maintaining consistent voltage distribution and power flow across the systems. Voltage fluctuations may occur in various operating scenarios of the electrical system, such as, for example, specific fault events or fault scenarios. Such fault events may include a battery of the system failing, during which it is desirable to drain power from the system as fast as possible.

Another non-limiting example includes a power spike or surge at the input of the DC power bus, causing an overvoltage scenario. The DC power bus may experience other scenarios that cause overvoltages in the power bus. Such overvoltages may cause the DC power bus voltage to raise to a level that exceeds an upper voltage limit of the power bus. In such overvoltage scenarios, the system in control of the DC power bus, such as the power distribution system 10 of the present disclosure, and in particular the controller 28, can be configured to control and redistribute excessive voltages so as to stabilize the voltage of the DC power bus 14.

In some embodiments, the redistributed excess voltage may be directed to a resistive element 48, 50, 52, 54, also referred to as a resistive heating element or electrical resistive element, arranged on a component of the aircraft 100. The resistive heating element 48, 50, 52, 54 can convert the excess voltage into heat so as to heat the component of the aircraft 100, the component being, for example, the wings 104 of the aircraft 100. In this way, the regulation of the voltage via the controller 28 of the power distribution system 10 can both regulate and stabilize the voltage of the DC power buses 14 and also heat components of the aircraft 100, such as de-icing the wings 104 of the aircraft 100.

As can be seen in FIG. 2, the power distribution system 10 includes a power supply circuit 12 including a DC power bus 14, the DC power bus 14 receiving input voltage from an external source. The DC power bus 14 may include a positive side 16 and a negative side 18. In some embodiments, the DC power bus 14 may have a first voltage that is received from the external source.

The power distribution system 10 can further include a voltage redistribution subsystem 42 including at least one resistive heating element 48, 50, 52, 54 coupled to the wings 104 of the aircraft 100, as shown in FIG. 2. Illustratively, the subsystem 42 includes four resistive heating elements 48, 50, 52, 54, although other embodiments may include more or fewer resistive heating elements. For example, some embodiments may include a single resistive heating element arranged in each wing 104, or three resistive heating elements arranged in each wing 104, or four resistive heating elements arranged in each wing 104. A person skilled in the art will understand that any number of resistive heating elements may be utilized based on the design requirements of the aircraft 100 and/or the power distribution system 10.

Illustratively, each resistive heating element 48, 50, 52, 54 includes two resistors or resistor arrangements arranged in parallel, as shown in FIG. 2. In some embodiments, the subsystem 42 can include more than two resistors arranged in parallel or a single resistor. In some embodiments, each resistive heating element 48, 50, 52, 54 includes two or more resistors arranged in series. A person skilled in the art will understand that the resistive heating elements 48, 50, 52, 54 can include any combination of resistors in parallel and series. For example, some of the resistive heating elements 48, 50, 52, 54 may include resistors in parallel while the other resistive heating elements 48, 50, 52, 54 may include resistors in series.

As shown in FIG. 2, the power distribution system 10 further includes a voltage manipulation element 32, 34, 36, 38 associated with each resistive heating element 48, 50, 52, 54. Each voltage manipulation element 32, 34, 36, 38 is configured to selectively adjust an amount of the first voltage of the DC power bus 14 that is directed to the corresponding resistive heating element 48, 50, 52, 54. Illustratively, the voltage manipulation element 32, 34, 36, 38 is a gate switch, also referred to as a gate drive or switch gate. A person skilled in the art will understand that other known components configured to manipulate voltage distribution may be utilized based on the design requirements of the power distribution system 10.

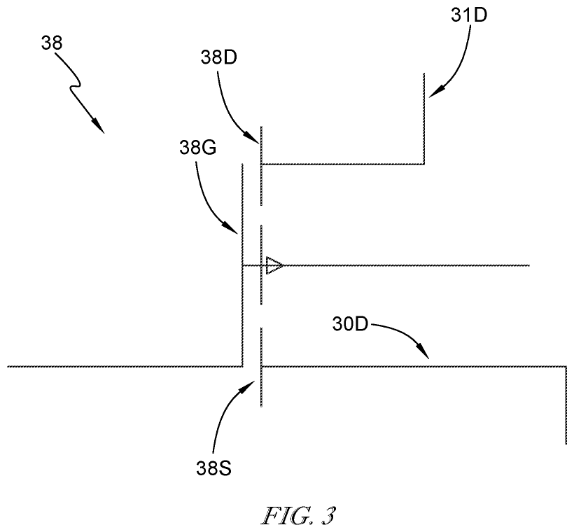

As shown in FIG. 3, an exemplary voltage manipulation element 38 configured as a gate switch may include a gate 38G, a supply end 38S, and a drain end 38D. The other voltage manipulation elements 32, 34, 36 may be similarly configured. As will be described in greater detail below, each voltage manipulation element 32, 34, 36, 38 configured as a gate switch is configured to be arranged in an on position and an off position.

In some embodiments, an electrical line 30A, 30B, 30C, 30D extends between and electrically interconnects the negative side 18 of the DC power bus 14 to the supply end 32S, 34S, 36S, 38S of the voltage manipulation element 32, 34, 36, 38, as shown in FIG. 2. Similarly, an electrical line 31A, 31B, 31C, 31D extends between and electrically interconnects the drain end 32D, 34D, 36D, 38D of the voltage manipulation element 32, 34, 36, 38 and the resistive heating element 48, 50, 52, 54.

Illustratively, the power distribution system 10 further includes a controller 28 electrically connected to the at least one voltage manipulation element 32, 34, 36, 38, as shown in FIG. 2. In some embodiments, the controller 28 may be a pulse width modulation controller. The controller 28 is configured to regulate the first voltage of the DC power bus 14. In particular, the controller 28 is programmed to selectively control each voltage manipulation element 32, 34, 36, 38. For example, with the voltage manipulation element 32, 34, 36, 38 configured as gate switches, the controller 28 is configured to selectively control the gate switch to the on and off positions.

In operation, the controller 28 is configured to control the gate switches 32, 34, 36, 38 in response to the first voltage of the DC power bus 14 being greater than a first threshold voltage, or in other words, in event of the DC power bus 14 experiencing an overvoltage scenario. As will be described in detail below, the controller 28 is configured to rapidly move the gate switches 32, 34, 36, 38 between the on and off positions so as to direct an amount or portion of the first voltage to the resistive heating elements 48, 50, 52, 54.

The frequency of the switching between the on and off positions of the gate switches 32, 34, 36, 38 directly affects the amount of the first voltage that is directed to the resistive heating elements 48, 50, 52, 54. The resistive heating elements 48, 50, 52, 54 convert the amount of the first voltage into heat and thereby regulate overvoltage of the first voltage of the DC power bus 14 while also heating the component to which the resistive heating elements 48, 50, 52, 54 are coupled to, such as the wings 104 of the aircraft 100.

In some embodiments, the controller 28 is configured to send a duty cycle signal to the gate switch 32, 34, 36, 38 indicative of a duty cycle to be applied to the gate switch 32, 34, 36, 38. A duty cycle can be any value between 0 and 1 that is indicative of a percentage of a period of a signal during which a switch is an on position versus an off position. In particular, the duty cycle to be applied to the gate switch 32, 34, 36, 38 is equal to a first duration in which the gate switch remains in the on position divided by a total cycle duration of the duty cycle signal, the total cycle duration being the first duration plus a second duration in which the gate switch in is the off position.

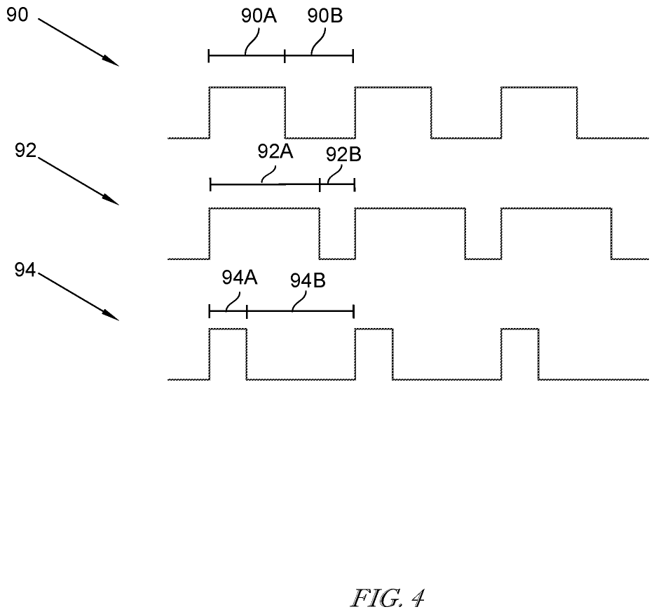

FIG. 4 shows three exemplary duty cycles 90, 92, 94 which can be sent to the gate switches 32, 34, 36, 38 via the duty cycle signal, as described above. A first non-limiting example of a duty cycle 90 shows an on position duration of approximately 60% (indicated by 90A) and an off position duration of approximately 40% (indicated by 90B). Such a duty cycle would be indicated by the number 0.6. A further non-limiting example of a duty cycle 92 shows an on position duration of approximately 80% (indicated by 92A) and an off position duration of approximately 20% (indicated by 92B). Such a duty cycle would be indicated by the number 0.8. Another non-limiting example of a duty cycle 94 shows an on position duration of approximately 20% (indicated by 94A) and an off position duration of approximately 80% (indicated by 94B). Such a duty cycle would be indicated by the number 0.2. These duty cycles are merely exemplary, and a person skilled in the art will understand that any number between 0 and 1 could be utilized as a potential duty cycle of the duty cycle signal.

The controller 28 is configured to send the duty cycle signal indicative of the duty cycle to be applied to each gate switch 32, 34, 36, 38. The duty cycle signal causes the gate switch 32, 34, 36, 38 to move between the on position and the off position such that the gate switch remains in the on position for the first duration indicated by the duty cycle value. For example, for the duty cycle 90 described above, the duty cycle signal would cause the gate switch 32, 34, 36, 38 to remain in the on position for 60% of the total duration of the period of the gate switch's on/off cycle.

The duration that the gate switch 32, 34, 36, 38 remains in the on position controls the amount of the first voltage that is directed to the resistive heating elements 48, 50, 52, 54. For example, the on position allows voltage to be directed to the resistive heating elements 48, 50, 52, 54, while the off position prevents voltage from being directed to the resistive heating elements 48, 50, 52, 54. In some embodiments, the controller 28 is configured to repeatedly send the duty cycle signal to the gate switches 32, 34, 36, 38 so as to repeatedly move the gate switches 32, 34, 36, 38 between the on and off positions at a first frequency.

The control of the duty cycle signal being sent to the gate switches 32, 34, 36, 38 allows for control of the voltage being directed to the resistive heating elements 48, 50, 52, 54. When the desired amount of voltage to be directed to the resistive heating elements 48, 50, 52, 54 increases, for example in high overvoltage scenarios, the duty cycle, and thus the duration that the gate switch 32, 34, 36, 38 remains in the on position is increased by the controller 28. Similarly, when the desired amount of voltage to be directed to the resistive heating elements 48, 50, 52, 54 decreases, for example in minor or low overvoltage scenarios, the duty cycle, and thus the duration that the gate switch 32, 34, 36, 38 remains in the on position is decreased by the controller 28.

A person skilled in the art will understand that the correlation between the increase in duty cycle and the necessary redistribution of the first voltage of the DC power bus 14 can vary based on many factors. For example, in scenarios in which overvoltage of the DC power bus 14 may not be relatively high, but the needs for de-icing the wings 104 of the aircraft 100 are great, the duty cycle may be increased in order to direct more voltage to the resistive heating elements 48, 50, 52, 54 for the conversion of the voltage to heat in order to de-ice the wings 104. Similarly, in scenarios in which overvoltage of the DC power bus 14 is great, but the needs for de-icing the wings 104 of the aircraft 100 are minimal, the duty cycle may be increased in order to stabilize the first voltage of the DC power bus 14, but not to the extent that would be necessary if moderate to heavy de-icing of the wings 104 was to also occur.

In some embodiments, the duty cycle to be applied to the gate switches 32, 34, 36, 38 is based on a difference between the first voltage and a first threshold voltage. Specifically, the first threshold voltage may be a predetermined upper voltage limit of the DC power bus 14 that, when exceeded, may risk or even begin to cause damage or failure of the associated components of the power bus 14. At least one sensor 70 may be connected to the DC power bus 14 in order to measure the first voltage of the power bus 14 and direct the reading to the controller 28 such that the controller 28 may access the difference between the threshold value and the first voltage.

In the illustrative embodiment, the greater the difference between the first voltage and a first threshold voltage, the greater the duty cycle value may be in order to increase the amount of voltage directed to the resistive heating elements 48, 50, 52, 54. In some embodiments, the first duration in which the gate switches 32, 34, 36, 38 remain in the on position of the duty cycle to be applied to the gate switch 32, 34, 36, 38 is directly proportional to the difference between the first voltage and the first threshold voltage.

In some embodiments, the controller 28 may be pre-programmed or determine in real time an amount of power to apply to each resistive heating element 48, 50, 52, 54 based on the duty cycle by utilizing the following Equation 1:

$$P ( {R}_{n} ) = ( {( Duty Cycle * DC Voltage )}^{2} ) / {R}_{n} \qquad ( 1 )$$

In Equation 1, Rₙ refers to n number of resistive heating elements. Although four resistive heating elements are shown in FIG. 2, which would correspond to R₁, R₂, R₃, R₄, more or fewer resistive heating elements may be utilized in the subsystem 42.

Illustratively, each resistive heating element 48, 50, 52, 54 is arranged within the wings 104 of the aircraft 100. In particular, first and second resistive heating elements 48, 50 are arranged in the first wing 104, while third and fourth resistive heating elements 48, 50 are arranged in the second wing 104. In some embodiments, the resistive heating elements 48, 50, 52, 54 may be embedded within the wings 104, such as within the skin, flaps, or ailerons of the wing 104. In some embodiments, the resistive heating elements 48, 50, 52, 54 may be coupled to the wings 104 in any manner known to a person skilled in the art.

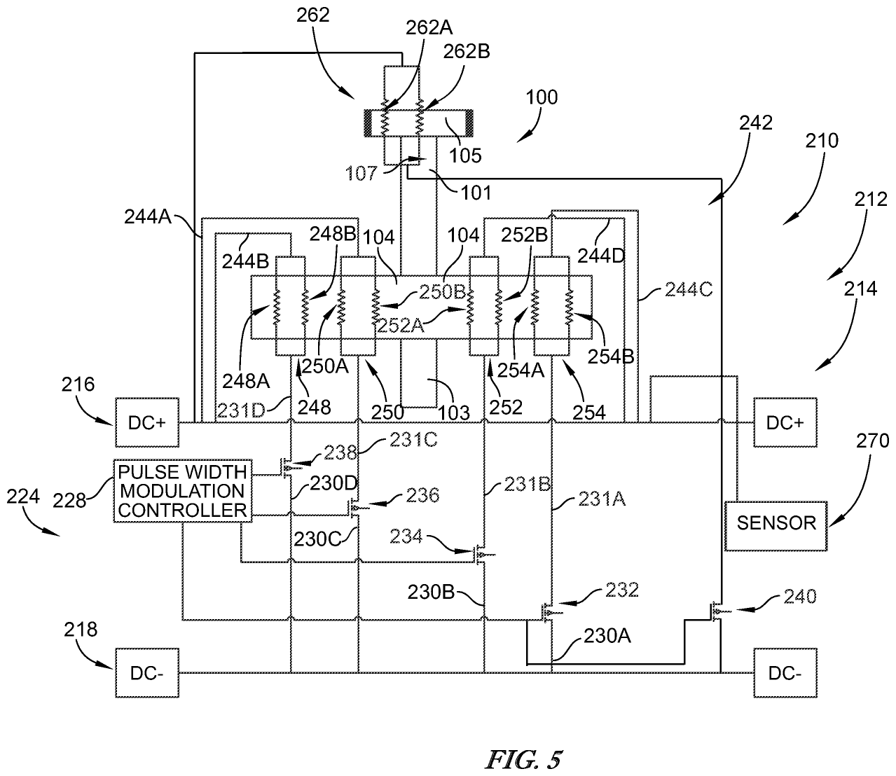

In some embodiments, the resistive heating elements may be arranged in other areas and components of the aircraft 100. For example, another embodiment of a power distribution system 210 is shown in FIG. 5. The power distribution system 210 is similar to the power distribution system 10 shown in FIGS. 1-4 and described herein. Accordingly, similar reference numbers in the 200 series indicate features that are common between the power distribution system 210 and the power distribution system 10. The description of the power distribution system 10 is incorporated by reference to apply to the power distribution system 210, except in instances when it conflicts with the specific description and the drawings of the power distribution system 210.

By way of a non-limiting example, the resistive heating elements 248, 250, 252, 254 may be arranged in the wings 104 of the aircraft 100, while an additional resistive heating element 262 is arranged within the horizontal stabilizer 105 of the aircraft 100 and a respective gate switch 240 connected to the resistive heating element 262 and configured to control voltage directed to the resistive heating element 262 from the first voltage of the DC power bus 214. The additional resistive heating element 262 may include resistors 262A, 262B arranged in parallel. The converted heat from the resistive heating element 262 may de-ice the horizontal stabilizer 105.

Although not shown, a person skilled in the art will understand that even further additional resistive heating elements may be arranged in other components of the aircraft 100 so as to regulate the voltage of the DC power bus and also provide heat, such as components of the engines (propulsion systems 106), various components of an interior cabin of the aircraft 100, or the nose 103 of the aircraft 100. Other non-limiting examples may include arranging the resistive heating elements to heat coolant fluid flowing in various systems of the aircraft 100, heating various components of the fuel system of the aircraft 100, or any other components that require heat.

The controller 28, as described above, may include memory and a processor. The memory and processor are in communication with each other. The processor may be embodied as any type of computational processing tool or equipment capable of performing the functions described herein. For example, the processor may be embodied as a single or multi-core processor(s), digital signal processor, microcontroller, or other processor or processing/controlling circuit.

The memory may be embodied as any type of volatile or non-volatile memory or data storage capable of performing the functions described herein, and may include additional storage. Moreover, the controller 28 may also include additional or alternative components, such as those commonly found in a computer (e.g., various input/output devices, resistors, capacitors, etc.). In other embodiments, one or more of the illustrative controllers 28 of components may be incorporated in, or otherwise form a portion of, another component. For example, the memory, or portions thereof, may be incorporated in the processor.

In operation, the memory may store various data and software used during operation of the controller 28 such as operating systems, applications, programs, libraries, and drivers. The memory is communicatively coupled to the processor via an I/O subsystem, which may be embodied as circuitry and/or components to facilitate input/output operations with the processor, the memory, and other components of the controller 28. In one embodiment, the memory may be directly coupled to the processor, for example via an integrated memory controller hub. Additionally, in some embodiments, the I/O subsystem may form a portion of a system-on-a-chip (SoC) and be incorporated, along with the processor, the memory, and/or other components of the controller 28, on a single integrated circuit chip (not shown).

The controller 28 may be configured to use any one or more communication technologies (e.g., wired, wireless and/or power line communications) and associated protocols (e.g., Ethernet, InfiniBand®, Bluetooth®, Wi-Fi®, WiMAX, 3G, 4G LTE, 5G, etc.) to effect such communication among and between system components and devices as described above, including but not limited to between the controller 28, the sensor 70, the DC power bus 14, a user interface, and any other component as would be understood by a person skilled in the art.

A method according to a further aspect of the present disclosure includes providing at least one wing of an aircraft and providing a power supply circuit. Providing the power supply circuit includes providing at least one DC power bus having a first voltage, electrically connecting at least one resistive heating element with the at least one DC power bus, coupling the at least one resistive heating element with the at least one wing of the aircraft, and arranging at least one voltage manipulation element in the power supply circuit that is configured to selectively adjust an amount of the first voltage that is directed to the at least one resistive heating element.

The method can further include electrically connecting a controller to the at least one voltage manipulation element of the power supply circuit, the controller being configured to regulate the first voltage of the DC power bus, the controller being programmed to selectively control the at least one voltage manipulation element in response to the first voltage of the DC power bus being greater than a first threshold voltage to vary an amount of the first voltage that is directed to the at least one resistive heating element to cause the at least one resistive heating element to convert the amount of the first voltage into heat and thereby regulate overvoltage of the first voltage of the DC power bus.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A power distribution system for an aircraft, comprising
at least one wing of the aircraft,
a power supply circuit including at least one DC power bus having a first voltage, at least one resistive heating element electrically connected with the at least one DC power bus and coupled with the at least one wing of the aircraft, and at least one voltage manipulation element configured to selectively adjust an amount of the first voltage that is directed to the at least one resistive heating element, and
a controller electrically connected to the at least one voltage manipulation element of the power supply circuit and configured to regulate the first voltage of the DC power bus, the controller programmed to selectively control the at least one voltage manipulation element in response to the first voltage of the DC power bus being greater than a first threshold voltage to vary an amount of the first voltage that is directed to the at least one resistive heating element to cause the at least one resistive heating element to convert the amount of the first voltage into heat and thereby regulate overvoltage of the first voltage of the DC power bus.

2. The power distribution system of claim 1, wherein the at least one voltage manipulation element is connected across the DC power bus and is a gate switch configured to be arranged in an on position and an off position, and wherein the controller is configured to selectively control the gate switch to the on and off positions.

3. The power distribution system of claim 2, wherein the gate switch is arranged along an electrical line extending between and electrically connecting a negative side of the DC power bus and the at least one resistive heating element.

4. The power distribution system of claim 2, wherein the controller is configured to send a duty cycle signal to the gate switch indicative of a duty cycle to be applied to the gate switch, wherein the duty cycle to be applied to the gate switch is equal to a first duration in which the gate switch remains in the on position divided by a total cycle duration of the duty cycle signal, the total cycle duration being the first duration plus a second duration in which the gate switch in is the off position, and wherein the duty cycle signal causes the gate switch to move between the on position and the off position such that the gate switch remains in the on position for the first duration such that the desired amount of the first voltage is directed to the at least one resistive heating element during the first duration.

5. The power distribution system of claim 4, wherein the controller is configured to repeatedly send the duty cycle signal to the gate switch so as to repeatedly move the gate switch between the on and off positions at a first frequency.

6. The power distribution system of claim 4, wherein the duty cycle to be applied to the gate switch is based on a difference between the first voltage and the first threshold voltage.

7. The power distribution system of claim 6, wherein the first duration in which the gate switch remains in the on position of the duty cycle to be applied to the gate switch is directly proportional to the difference between the first voltage and the first threshold voltage.

8. The power distribution system of claim 7, wherein the at least one resistive heating element includes a plurality of resistive heating elements arranged within the at least one wing, and wherein each resistive heating element of the plurality of resistive heating elements includes a corresponding gate switch electrically connected thereto and configured to adjust an amount of the first voltage that flows to the corresponding resistive heating element.

9. The power distribution system of claim 8, wherein the plurality of resistive heating elements include at least one group of at least two resistors arranged in parallel.

10. The power distribution system of claim 6, further comprising:
at least one sensor connected to the DC power bus and configured to measure the first voltage of the DC power bus.

11. The power distribution system of claim 1, further comprising:
at least one additional resistive heating element electrically connected across the at least one DC power bus and arranged within a further component of the aircraft separate from the at least one wing.

12. A power distribution system for an aircraft, comprising
a power supply circuit including at least one DC power bus having a first voltage and at least one electrical resistive element electrically connected with the at least one DC power bus, and
a controller electrically connected to the power supply circuit and configured to regulate the first voltage of the DC power bus, the controller being configured to selectively control an amount of the first voltage that is directed to the at least one electrical resistive element in response to the first voltage being greater than a first threshold voltage to vary an amount of the first voltage that is directed to the at least one electrical resistive element to cause the at least one electrical resistive element to regulate overvoltage of the first voltage of the DC power bus.

13. The power distribution system of claim 12, further comprising
at least one component of the aircraft,
wherein the at least one electrical resistive element is coupled with the at least one component of the aircraft.

14. The power distribution system of claim 13, wherein the power supply circuit further includes at least one voltage manipulation element configured to selectively adjust an amount of the first voltage that is directed to the at least one resistive heating element, and wherein the controller is programmed to selectively control the at least one voltage manipulation element in response to the first voltage of the DC power bus being greater than the first threshold voltage.

15. The power distribution system of claim 14, wherein the at least one voltage manipulation element is connected across the DC power bus and is a gate switch configured to be arranged in an on position and an off position, and wherein the controller is configured to selectively control the gate switch to the on and off positions.

16. The power distribution system of claim 15, wherein the controller is configured to send a duty cycle signal to the gate switch indicative of a duty cycle to be applied to the gate switch, wherein the duty cycle to be applied to the gate switch is equal to a first duration in which the gate switch remains in the on position divided by a total cycle duration of the duty cycle signal, the total cycle duration being the first duration plus a second duration in which the gate switch in is the off position, and wherein the duty cycle signal causes the gate switch to move between the on position and the off position such that the gate switch remains in the on position for the first duration such that the desired amount of the first voltage is directed to the at least one resistive heating element during the first duration.

17. The power distribution system of claim 16, wherein the duty cycle to be applied to the gate switch is based on a difference between the first voltage and the first threshold voltage.

18. The power distribution system of claim 17, wherein the first duration in which the gate switch remains in the on position of the duty cycle to be applied to the gate switch is directly proportional to the difference between the first voltage and the first threshold voltage.

19. The power distribution system of claim 18, wherein the at least one resistive heating element includes a plurality of resistive heating elements arranged within the at least one component, and wherein each resistive heating element of the plurality of resistive heating elements includes a corresponding gate switch electrically connected thereto and configured to adjust an amount of the first voltage that flows to the corresponding resistive heating element.

20. A method comprising:
providing at least one wing of an aircraft,
providing a power supply circuit, including
providing at least one DC power bus having a first voltage,
electrically connecting at least one resistive heating element with the at least one DC power bus,
coupling the at least one resistive heating element with the at least one wing of the aircraft, and
arranging at least one voltage manipulation element in the power supply circuit that is configured to selectively adjust an amount of the first voltage that is directed to the at least one resistive heating element, and
electrically connecting a controller to the at least one voltage manipulation element of the power supply circuit, the controller being configured to regulate the first voltage of the DC power bus, the controller being programmed to selectively control the at least one voltage manipulation element in response to the first voltage of the DC power bus being greater than a first threshold voltage to vary an amount of the first voltage that is directed to the at least one resistive heating element to cause the at least one resistive heating element to convert the amount of the first voltage into heat and thereby regulate overvoltage of the first voltage of the DC power bus.
